(19) United States
(12) Patent Application Publication
(10) Pub. No.: US 2008/0233357 A1
(43) Pub. Date: Sep. 25, 2008

(54) Sandwich Structures and Methods of Making Same

(76) Inventor: Steven J. Winckler, Troy, NY (US)

Correspondence Address: GFD PATENTS, LLC, P.O. BOX 752, CLIFTON PARK, NY, 12065, US

(21) Appl. No.: 11/995,534

(22) PCT Filed: Sep. 27, 2006
(86) PCT No.: PCT/US06/37816

§ 371 Date: Jan. 12, 2008

Related U.S. Application Data
(60) Provisional application No. 60/720,828, filed on Sep. 27, 2005.

(51) Int. Cl. B32B 3/20; B29C 59/14

(52) U.S. Cl. 428/178; 264/446

(57) ABSTRACT

Sandwich structures and methods of making same. A core material structure based on blow molded segments has been developed to facilitate the use of very thick sandwich panels, 4 to 72 in. thick. The basic concept uses an array of hollow rectangular segments arranged in a sheet, to form the core, with sandwich face skins on top and bottom. The hollow core segments have wall thicknesses from about 0.015 to 0.250 in. Once the blow molded core (BMC) segments and skins are bonded together, using resin infusion (or other molding techniques) the sides of the segments form webs which act as though they were continuous; like a giant rectangular honeycomb. Sandwich structure thicknesses of 4 to 18 in. have been demonstrated.

### FIELD OF USE

The present invention relates generally to building materials and methods of using building materials, and more specifically to molded sandwich structure(s) and methods of making molded sandwich structure(s).

### BACKGROUND

Core materials are an important component in many sandwich structure applications from skis, boats, and snow boards, to aerospace structures and highway bridges; just to name a few. As acceptance of sandwich construction has grown, so has the interest in making larger and larger structures. Structures such as highway bridges, ship fenders, helicopter landing platforms and bridge decking are considered as viable candidates for sandwich construction. One limitation of traditional core materials is that they were developed for relatively thin sandwich structures.

There is a need for providing core materials for molded sandwich structure(s) that offer increased thickness sandwich structures.

### SUMMARY OF THE INVENTION

A first aspect of the present invention provides a sandwich structure, comprising: a plurality of operably coupled contiguous core segments, each core segment being characterized by only one inner cavity and an outer wall surrounding the inner cavity, wherein the walls do not allow communication between the cavities of the contiguous core segments, the walls of the contiguous core segments having channels and spaces therebetween, the channels and spaces being essentially completely filled with a cured resin, wherein a portion of an outer surface of the walls and channels have been oxidized by treatment with a flame, corona discharge or chemical oxidizing agent before the channels and spaces therebetween have been essentially completely filled with the cured resin, so that the portion of the outer surface of adjacent walls and channels are chemically bonded to the adjacent walls and channels.

A second aspect of the present invention provides a method of forming a sandwich structure, comprising: providing a plurality of core segments, each core segment being characterized by only one inner cavity and an outer wall surrounding the inner cavity, wherein the walls do not allow communication between the cavities, and wherein the walls of the core segments have channels; oxidizing at least part of an outer surface of walls and channels of the plurality of core segments by treatment with a flame, corona discharge or chemical oxidizing agent; treating the outer surface of the walls and channels of the plurality of core segments with an adhesion promoter; assembling the plurality of core segments to form a an array of contiguous core segments, wherein the channels and spaces between adjacent core segments of the array of contiguous core segments are in fluid communication with a resin supply; providing the uncured resin supply through the channels and spaces between the walls of the contiguous core segments so that the at least part of the outer surface of the walls and channels of adjacent core segments are chemically bonded to the walls and channels of another adjacent core segment; and curing the resin to form the sandwich structure.

A third aspect of the present invention provides a sandwich construction, comprising a structure having at least one layer of core segments consisting of a combination of relatively high-strength facing materials intimately bonded to and acting integrally with the low-density core segments.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 depicts a front cross sectional view of an embodiment of a sandwich structure 10, in accordance with embodiments of the present invention;

FIG. 2 depicts a cross sectional view along a longitudinal plane of the core segment(s) 22 of the sandwich structure 10, in accordance with embodiments of the present invention;

FIG. 3 depicts a front cross sectional view of a portion of the outer wall 24 of the core segment(s) 20 of the sandwich structure 10, in accordance with embodiments of the present invention;

FIG. 4 depicts the front cross sectional view of a portion of the outer wall 24 of the core segment(s) 20 of the sandwich structure 10, in accordance with embodiments of the present invention;

FIG. 5 depicts a sandwich structure 40, in accordance with embodiments of the present invention;

FIG. 6 depicts a top planar view of a sandwich structure 80, in accordance with embodiments of the present invention;

FIG. 7 depicts a top planar view of a sandwich structure 90, in accordance with embodiments of the present invention;

FIG. 8 depicts a flow diagram for a method 50 for forming sandwich structure(s), in accordance with embodiments of the present invention;

FIG. 9 depicts a front cross sectional view of an infusion mold 60 for forming sandwich structure(s), in accordance with embodiments of the present invention;

FIG. 10 depicts a front cross sectional view of the infusion mold 60 depicted in FIG. 9, further comprising an array of a plurality of contiguous core segments 22, in accordance with embodiments of the present invention; and

FIG. 11 depicts a front cross sectional view of the infusion mold 60 depicted in FIG. 10, in accordance with embodiments of the present invention.

### DETAILED DESCRIPTION OF THE INVENTION

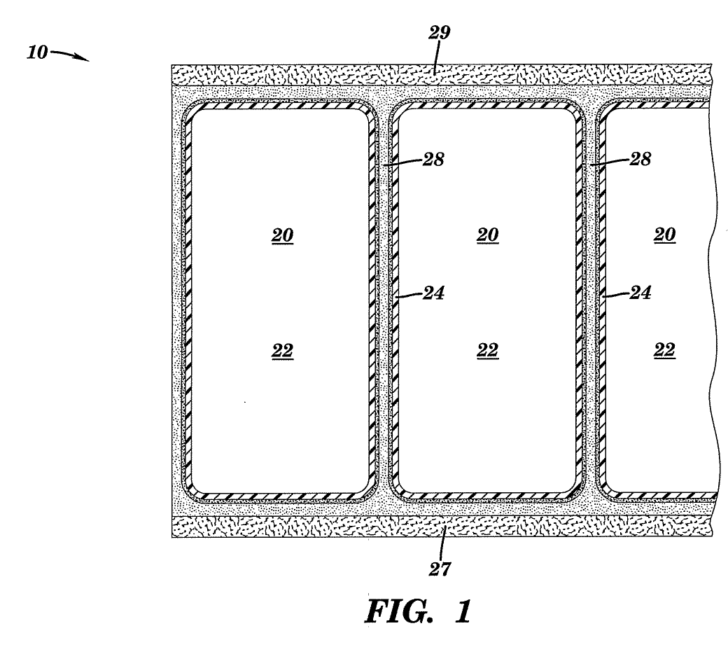

FIG. 1 depicts a front cross sectional view of a sandwich structure 10 of the present invention, comprising: a plurality of operably coupled contiguous core segments 22, each core segment 20 being characterized by only one inner cavity 22 and an outer wall 24 surrounding the inner cavity 22. Hereinafter, “operably coupled” or “operably coupling” means physically and mechanically attaching the contiguous core segments 22, such as by forming a chemical bond between the outer surface 32 of outer walls 24 of the contiguous core segments 22 or 42 and an intervening resin layer 36 or 38, as depicted in FIGS. 1-4 and described in associated text, infra.

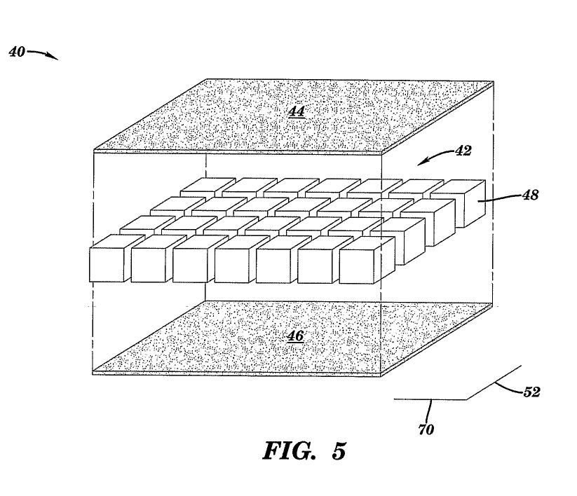

The outer walls 24 do not allow communication between the cavities 22 of the contiguous core segments 22. One definition of a “sandwich structure” is a combination of reinforcing fibers surrounded by a stress-transferring medium or “matrix” that allows the development of the full properties of the reinforcing fibers. Referring to FIGS. 1, and FIGS. 9-10, the top layer 29 and the bottom layer 27 of fabric are the reinforcing fibers and the curable resin is the stress-transferring medium or “matrix” of sandwich structure 10. Referring to FIG. 5, the top layer 44 and the bottom layer 46 of fabric are the reinforcing fibers and the curable resin is the stress-transferring medium or “matrix” of sandwich structure 40. The level of properties developed within a volume can be described approximately by the rule of mixtures, which, simply stated, predicts the resultant properties displayed in any direction to be proportional to the volume fraction of fibers aligned in that direction.

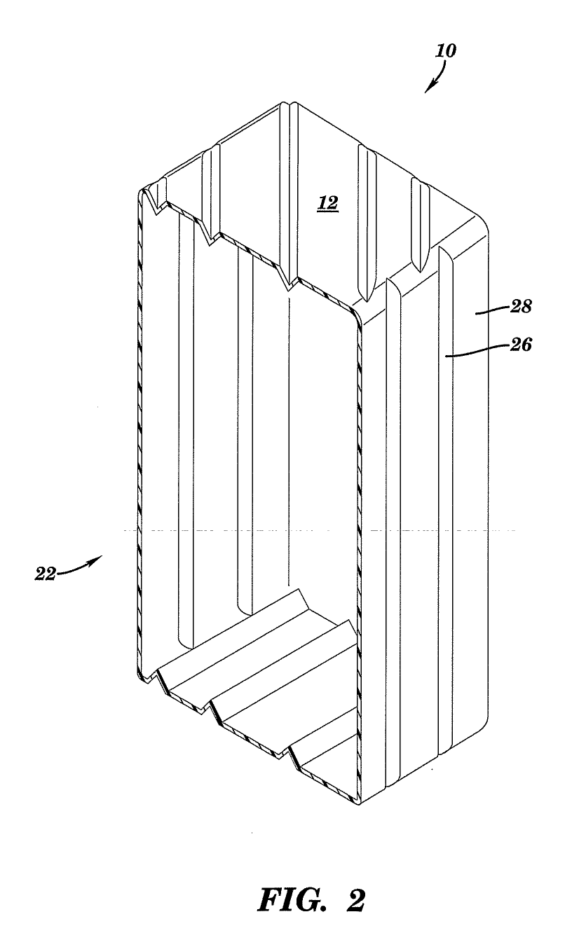

FIG. 2 depicts a a cross sectional view along a longitudinal plane view of the core segment(s) 22 of the sandwich structure 10, as depicted in FIG. 1 and described in associated text, the outer walls 24 of the contiguous core segments 22 having channels 26 and spaces 28 therebetween, the channels 26 and spaces 28 being essentially completely filled with a cured resin.

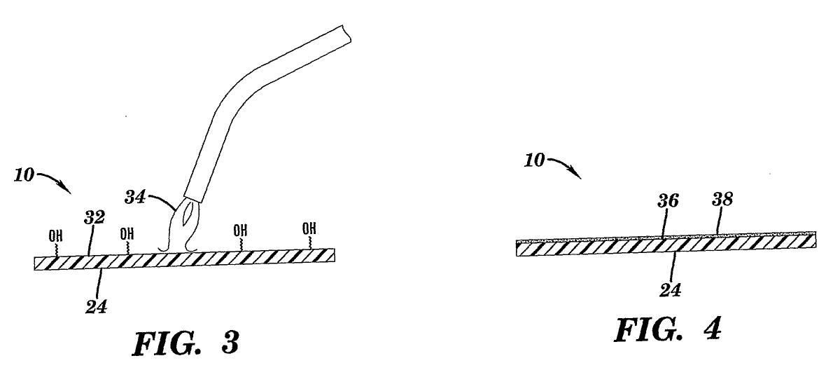

FIG. 3 depicts a front cross sectional view of a portion of the outer wall 24 of the core segment(s) 20 of the sandwich structure 10, as depicted in FIGS. 1-2, and described in associated text, having the channels 26 and spaces 28 therebetween. An outer surface 32 of the walls 24 and channels 26 has been oxidized by treatment with a flame 34, corona discharge or chemical oxidizing agent. In FIG. 3, the oxidized surface of the walls 24 and channels 26 is designated by hydroxyl (—OH) groups.

FIG. 4 depicts the front cross sectional view of a portion of the outer wall 24 of the core segment(s) 20 of the sandwich structure 10, as described in FIGS. 1-3 and described in associated text, having the channels 26 and spaces 28 therebetween. The oxidized surface of the channels 26 and spaces 28, designated by hydroxyl (—OH) groups, have been essentially completely filled with a mixture that includes a cured resin therebetween, so that the outer surfaces 32 of adjacent walls 24 and channels 26 are chemically bonded. Alternatively, the oxidized surface of the channels 26 and spaces 28, designated by hydroxyl (—OH) groups may have been treated with an adhesion promoter prior to essentially completely filling the channels 26 and spaces 28 to form the layer 36 that includes the cured resin therebetween, so that the outer surface 32 of the adjacent walls 24 and channels 26 are chemically bonded. The layer 36 may additionally include a fiber glass mat.

FIG. 5 depicts a sandwich structure 40, comprising an array of hollow core segments 42 as the core, top face skin 44 and bottom face skin 46 on the top and bottom in the thickness direction of the sandwich structure 40. The core segments 42 are then bonded together with resin infusion (or other molding processes), and the chemically bonded surfaces 48 of the core segments 42 act as continuous webs in two directions at the same time, e.g., the direction shown by arrow 70 and the direction shown by the arrow 52.

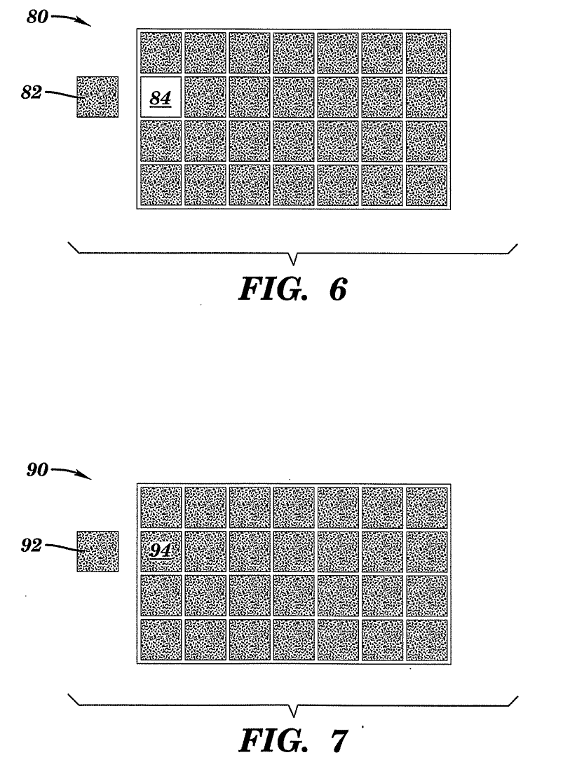

FIG. 6 depicts a top planar view of a sandwich structure 80, in which one of the core segments has demonstrated adhesion failure (lack of adhesion) between an oxidized surface 84 and an overlying layer of fabric (not shown). The lack of adhesion is because the oxidized surface 84 has not been treated with an adhesion promoter prior to the channels 26 and spaces 28 of the sandwich structure 80 being essentially completely filled with a material that includes the cured resin therebetween. The lack of adhesion results because the oxidized surface 84 of the walls 24 and channels 26 of the sandwich structure 80 are not chemically bonded to the adjacent fabric. Lack of adhesion and chemical bonding between the oxidized surface 84 and the overlying fabric in sandwich structure 80 is shown by the white color of the surface 84.

In contrast, the oxidized surface 82 of a separate core segment has been treated with an adhesion promoter prior to its channels 26 and spaces 28 being essentially completely filled with a material that includes the cured resin therebetween. The oxidized surface 82 of the walls 24 and channels 26 of the separate core segment adhere and have become chemically bonded to an adjacent fabric (not shown). Adhesion and chemical bonding between the outer surface 82 and the overlying fabric in separate core segment is shown by the black color of the surface 82 of the separate core segment.

FIG. 7 depicts a top planar view of a sandwich structure 90, in which one of the core segments has demonstrated adhesion between an oxidized surface 94 and an overlying layer of fabric (not shown). Adhesion between the oxidized surface 94 and the fabric resulted because the oxidized surface 94 of one of the core segments has been treated with an adhesion promoter prior to the channels 26 and spaces 28 of the sandwich structure 90 being essentially completely filled with a material that includes the cured resin therebetween. Adhesion results because the oxidized surface 94 of the walls 24 and channels 26 of the sandwich structure 90 are chemically bonded to an adjacent fabric. Adhesion and chemical bonding between the oxidized surface 94 and the overlying fabric in sandwich structure 90 is shown by the black color of the surface 94 of the sandwich structure 90.

In like manner, chemical bonding between the oxidized surface 92 of a separate core segment and an overlying fabric is shown by the same black color of the surface 92 of the separate core segment and the surface 94 of the sandwich structure 90.

Dimensions of the core segments 22 and 42, depicted in FIGS. 1-2 and 5 may be from about 4 in.×4 in.×8 in. to about 16 in.×16 in.×72 in., and a wall thickness of the core segments 22 and 42 is less than or equal to from about 0.015 to about 0.25 in.

Referring to FIGS. 1-5, core segments 22 or 42 are important components in many sandwich structures such as skis, boats, and snow boards, to aerospace structures and highway bridges; just to name a few. As acceptance of sandwich construction has grown, so has the interest in making larger and larger sandwich structure(s) 10 or 40. A definition of “Sandwich Construction“ a structure having at least one layer of core segments 22 or 42 consisting of a combination of relatively high-strength facing materials intimately bonded to and acting integrally with the low-density core segments 22 or 42 of the present invention.

In one embodiment, the sandwich construction thickness is at least 4 in. thick.

In one embodiment, a core density of the sandwich construction was from about 4.8 to about 5.4 pounds per cubic foot (77 and 87 kg/m³).

In one embodiment, a core density of the sandwich construction was from about 1.0 to about 30.0 pounds per cubic foot.

In one embodiment, the outer surface of the walls and channels of the sandwich construction have been have been treated with an adhesion promoter after the outer surface of the walls and channels have been oxidized by treatment with a flame, corona discharge or chemical oxidizing agent.

Highway bridges, ship fenders, helicopter landing platforms and bridge decking are considered as viable candidates for sandwich construction. The low-density core segments 22 or 42 of the present invention are an improvement over core materials that are for relatively thin sandwich structures, from a fraction of an inch up to a few inches thick because the low-density core segments 22 or 42 of the present invention are typically closed cell. Hereinafter “closed cell” means there is no fluid communication between the hollow chambers or cavities 20 of the core segments 20 or 42 of sandwich structures 10 or 40.

The present sandwich structure(s) 10 or 40 overcome this thickness limitation. In one advantageously strong embodiment of the sandwich structure 40, deep box sections are formed by pultrusion of commingled fibers and resin pushed through a die, where the webs of the box function like the core segments 22, separating the top and bottom laminates and providing shear capability to the cross section. In the pultrusion process, material is physically pulled through the die by a pulling mechanism. This is a good approach for some applications, but uses webs in only one direction, and consequently has the majority of its shear capability in one direction. Some configurations have been tried to help this situation, for example, angling the webs in box section or filling the open space with foam in an attempt to get shear capability transverse to the webs. This does help but it is not as effective as having webs in two mutually perpendicular directions at the same time. Some boat builders make this type of structure when they separate the lower floor in the boat from the hull with an “egg-crate” structure comprised of intersecting longitudinal and transverse framing. The inner floor and hull are attached to the “egg crate” providing a strong structure with shear capability in two directions.

### Blow Molding Segments

The core segments 22, depicted in FIGS. 1-2 and the hollow core segments 42 depicted in FIG. 5 may be blow molded core (BMC) segments, made using a process known as extrusion blow molding. A thermoplastic material is melted and pumped with an extruder through an annular orifice, producing a vertical tube of molten plastic. This tube is quickly clamped between the halves of a two part mold, pinching off the top and bottom, thus sealing the tube. A hollow pin is then inserted, usually through the top of the mold, and through the molten plastic. Air is then forced into the molten tube, expanding it to quickly fill the mold. This all happens very quickly, in a matter of seconds, with typical cycle times in the 15-60 second range depending the part. Thermoplastic materials suitable for extrusion blow molding include high density polyethylene (HDPE), low density polyethylene (LDPE), polypropylene (PP), polyvinyl chloride (PVC), polycarbonate (PC), polyethylene terephthalate (PET), polyphenylsulfone, polyethersulfone, phenolics, and a variety of other theremoset resins.

BMC segments used for testing in the present work are made with HDPE. They are 4 in.×4 in.×8 in. in size, and weigh about ¼ pound each (114 grams). The segments are molded with grooves on the surface to promote resin distribution, and improved buckling resistance.

### Structural Configurations

The core segments 22, depicted in FIGS. 1-2 and the hollow core segments 42 depicted in FIG. 5 can be used alone or in combination with fiber reinforcement (e.g. fiber glass fabrics or mats) in a variety of configurations depending on the requirements of the application. In one embodiment the core segments 22 or 42 used without fiberglass layers between the channels 26 and spaces 28. In another embodiment fiberglass layers are inserted between the channels 26 and spaces 28 of the core segments 22 or 42 in the direction shown by the arrow 70 and/or the arrow 52. In another embodiment, fiberglass layers are inserted between the channels 26 and spaces 28 of the core segments 22 or 42 on four sides of the core segments 22 or 42. Lightly loaded sandwich structure(s) 10 or 40 may use the segments alone, where the core segment material forms the webs and provides the required strength once bonded together. If additional strength (or stiffness) is required in the direction shown by the arrow 70 and/or 52, fiber reinforcement can be inserted between the core segments 22 or 42 and greatly improve the structural properties in that direction. Wrapping the core segments 22 or 42 on four sides will provide additional reinforcement in perpendicular directions. In an embodiment, the core segments 22 or 42 are wrapped with a 72 oz./sq.yd. (2450 gsm) stitch-bonded fabric.

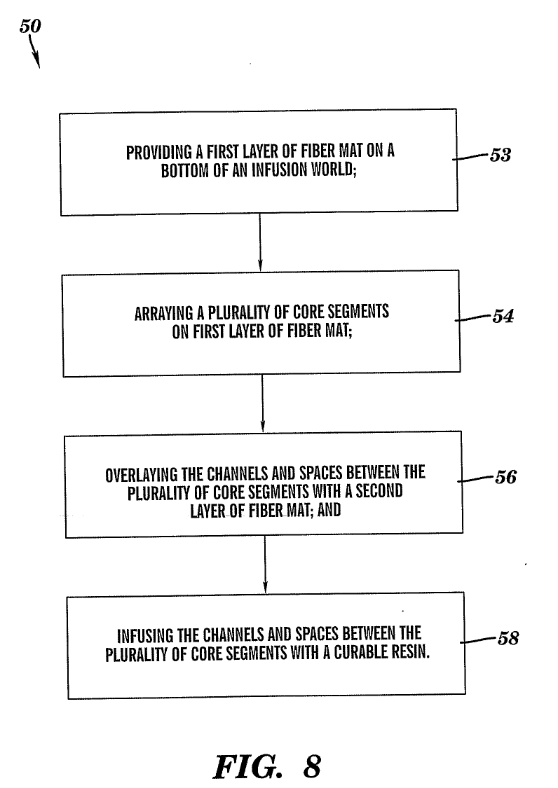

FIG. 8 depicts a flow diagram for a method 50 using vacuum assisted resin transfer molding for forming the sandwich structure(s) 10 or 40, as depicted in FIGS. 1-5, supra. However, the sandwich structure(s) 10 or 40 may be made by alternative methods of making molded sandwich structure(s) using standard or well known or typical sandwich structure manufacturing techniques vacuum assisted resin transfer molding, resin transfer molding, wet layup, vacuum bag, compression molding

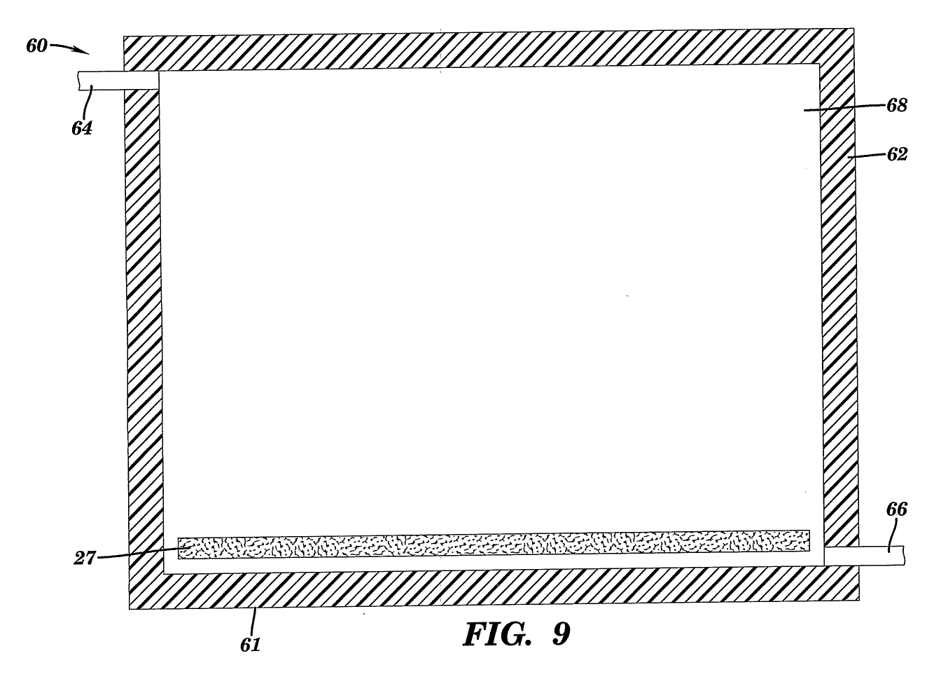

FIG. 9 depicts a front cross sectional view of an infusion mold 60 for forming the sandwich structure(s) 10 or 40, as depicted in FIGS. 1-5, supra. In a step 54 of the method 50, depicted in FIG. 8 and described in associated text, supra, a first layer 27 of fiber mat is provided on a bottom 61 of an infusion mold 60. The infusion mold 60 comprises an infusion resin intake port 66 for introducing the curable resin through a wall 62 of the infusion mold 60 into the infusion mold cavity 68, and a vacuum port 64 for providing a negative pressure differential between ports 64 and 66 that may draw curable resin into the infusion mold cavity 68.

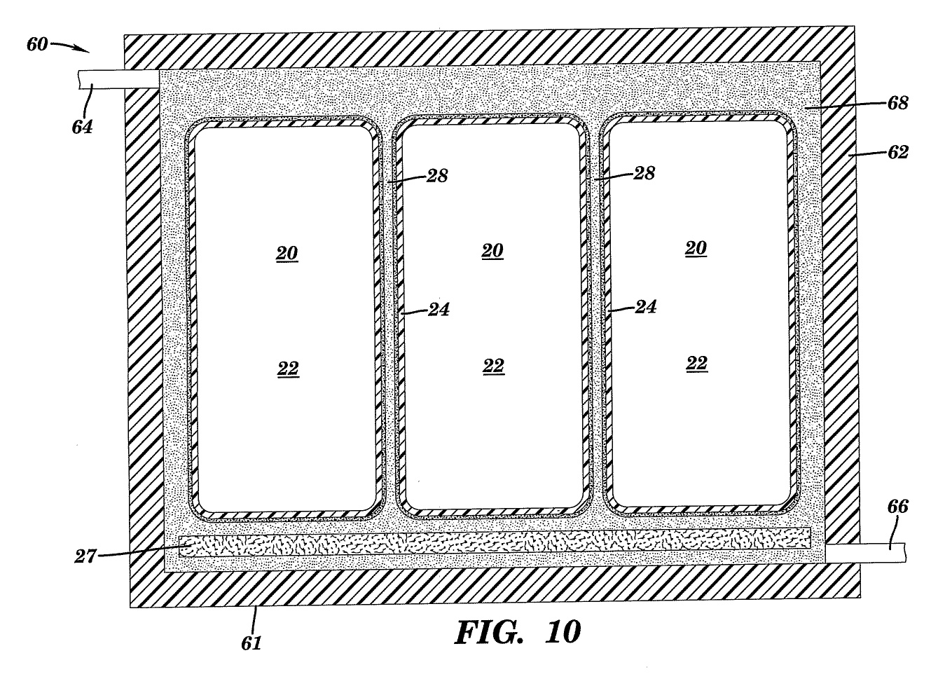

FIG. 10 depicts a front cross sectional view of the infusion mold 60 depicted in FIG. 9, further comprising an array of a plurality of contiguous core segments 22. In a step 54 of the method 50, depicted in FIG. 8 and described in associated text, supra, a plurality of the contiguous core segments 22, as depicted in FIGS. 1-2, are arrayed on the first layer 27 of the fiber mat. Each of the plurality of contiguous core segments 22 have an inner cavity 20 and outer wall 24, the plurality of contiguous core segments 22 having channels 26 and spaces 28 therebetween, as depicted in FIGS. 1-2 and described in associated text, supra.

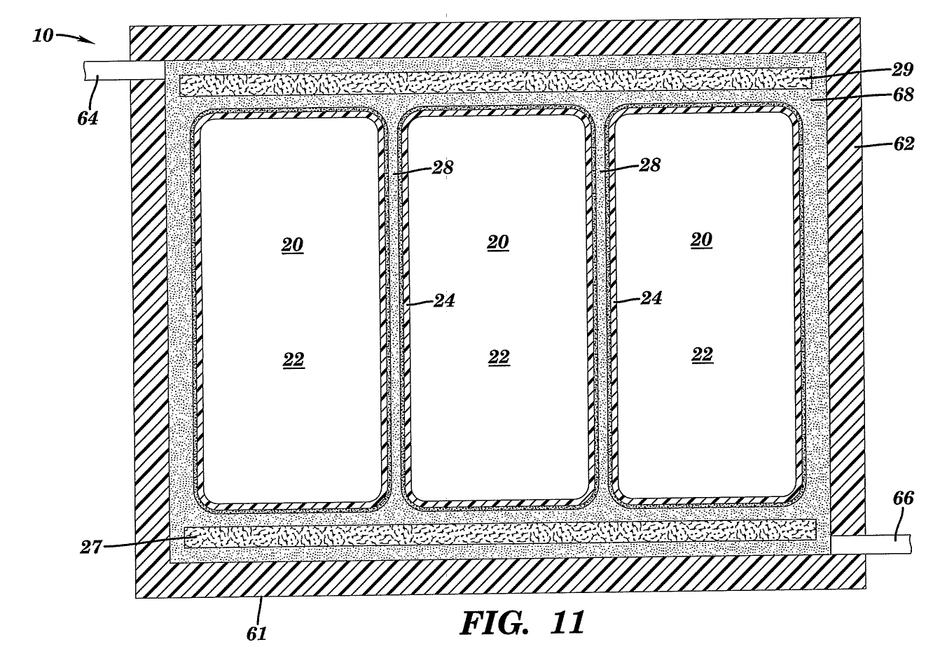

FIG. 11 depicts a front cross sectional view of the infusion mold 60 depicted in FIG. 10, further comprising overlaying a fabric 29 on the array of the plurality of the contiguous core segments 22 and infusing the cavity of the mold 68 with a curable resin. In the step 56 of the method 50, depicted in FIG. 8 and described in associated text herein, the channels 26 and spaces 28 on a top surface 12 of the plurality of core segments 22, depicted in FIG. 2, supra, are overlayed with a second layer 29 of fiber mat. In the step 58 of the method 50, depicted in FIG. 8 and described in associated text herein, the channels 26 and spaces 28 between the array of the plurality of core segments 22 and the first and second layers of fiber mat 27 and 29 are infused with a curable resin to form the sandwich structure(s) 10 or 40.

The curable resin may be an epoxy resin, a polyester resin or a vinyl ester resin. The polyester resin may be an unsaturated polyester, cured with Methylethylketone peroxide (MEKP) catalyst. Epoxy or polyepoxide is a thermosetting epoxide polymer that cures (polymerizes and crosslinks) when mixed with a catalyzing agent or “hardener”.

The epoxy resin may be anhydride cured or amine cured. The polyester and vinyl ester resins may be cured with methylethylketone peroxide (MEBK).

The primary components for the adhesion promoter are a surfactant and a coupling agent. The surfactant, so called because it forms a film on the thermoplastic resin such as high (HDPE) or low density polyethylene (LDPE) or high (HDPP) or low density polypropylene (LDPP), is chemically similar to the curable resin for which the adhesion promoter is chosen. In one embodiment, the surfactant is an epoxy edmulsion (45% solids, 174 epoxy equivalent weight (EEW) epoxy resin). The coupling agent may be an amino-alkoxysilane compound such as gamma-Aminopropyltriethoxysilane) available from OSi, Inc., or gamma-aminopropyltriethoxysilane. Alternatively the coupling agent may be gamma-aminopropylaminoethyltrimethoxysilane availabel from HULS, Piscataway, N.J. Alternatively, the coupling agent may be N-(2-aminothyl)-3-aminopropyltrimethoxysilane. Alternatively, the coupling agent may be a multi-functional amine containing organic compound. The multifunctional amine containing organic compound is a carbon, hydrogen and nitrogen containing compound which either has at least two amine groups or has one or more amine group(s) and at least one functional group other than the amine functional group(s). The compound may also contain one or more of the elements such as oxygen, sulphur, halogen and phosphorous in addition to carbon, hydrogen and nitrogen, silicon, titanium, zirconium or aluminium. Examples of multi-functional amine containing compounds having at least one amino group include compounds of groups A and B, wherein group A includes low and/or high molecular weight organic amines, that is compounds containing two or more amine functional groups. The amines can be primary, secondary, and/or tertiary amines, or a mixture of these three types of amines, however, primary and secondary amines are preferred due to their higher chemical reactivities in, comparison with the tertiary amines. Group B chemicals include multi-functionalorganic compounds in which at least one amine functional group and one or more non-amine functional groups are presented. The non-amine functional groups include, but are not limited to, the following functional groups and their mixtures: perfluorohydrocarbons, unsaturated hydrocarbons, hydroxyls/phenols, carboxyls, amides, ethers, aldehydes/ketones, nitrites, nitros, thiols, phosphoric acids, sulfonic acids, halogens. The coupling agent chemically bonds the fiber and the thermoplastic resin to the curable resin.

The adhesion promoter may also contain surfactants Polyvinylpyrrolidone 20% solution (C₆H₉NO)ₙ and/or polyethyleneglycol (PEG) 400 Monooleate and a pH modifier such as acetic acid. In one embodiment the pH of the adhesion promoter was adjusted to a pH less than 6.0. Table 1, infra, lists adhesion results and compositions of the adhesion promoter in weight percent. Hereinafter, “good” adhesion, as a criterion for adhesion in Table 1, supra, is defined as shear strength greater than or equal to 40 psi. (See paragraphs 62-68 for a discussion of measuring shear strength).

In another embodiment, the method 50, depicted in FIG. 8 and described in associated text herein, for forming the sandwich structure(s) 10 or 40, comprises: providing a plurality of cores 22, each core 22 being characterized by only one inner cavity 20 and an outer wall 24 surrounding the inner cavity 20, wherein the walls 24 do not allow communication between the cavities 20, and wherein the walls of the cores 22 have channels 26, as depicted in FIGS. 9-10 and described in associated text herein. Hereinafter, “core segments” and “cores” are the same as the core segments 22 or 42 depicted in FIGS. 1-2 and 5 and described in associated text herein.

Dimensions of the core segments or cores 22 or 42, depicted in FIGS. 1-2 and 5 may be from about 4 in.×4 in.×8 in. to about 16 in.×16 in.×72 in., and a wall thickness of the core segments 22 and 42 is less than or equal to from about 0.015 to about 0.25 in.

In this embodiment, at least part of an outer surface 32 of the walls 24 and channels 26 of the plurality of cores 22 are oxidized by treatment with a flame, corona discharge or chemical oxidizing agent, as depicted in FIG. 3 and described in associated text herein.

In this embodiment the outer surface 32 of the walls 24 and channels 26 of the plurality of cores 22 may be treated with an adhesion promoter to form an adhesion layer 38, depicted in FIG. 4 and described in associated text herein.

In this embodiment, the plurality of cores 22 are assembled to form a an array of contiguous cores 22, so that when the uncured resin supply is fed through the channels 26 and spaces 28 between the walls 24 of the contiguous cores 22, the adhesion layer 38 on the outer surface 32 of the channels 26 and spaces 28 between adjacent cores 22 of the array of contiguous cores 22 is in fluid communication with the resin supply, as depicted in FIG. 11 and described in associated text herein.

In this embodiment, the sandwich structure(s) 10 or 42 are formed by curing the resin because the outer surface 32 of the walls 24 and channels 26 of adjacent cores 22 become chemically bonded.

In one embodiment of the method 50, the plurality of cores 22 may be made of a thermoplastic material such as low density polyethylene material, LDPE, a polypropylene material, PP, a high density polyethylene material, HDPE , , , a poly vinyl chloride material, PVC, a polyethylene terephthalate material, PET, a polycarbonate material, PC, a polysulfone material, a polyphenyl sulfone material, a polyether imide, and polyether sulfone material.

In one embodiment the adhesion promoter advantageously includes an amino-alkoxysilane coupling agent such as gamma-methacryloxypropyltrimethoxysilanemethacryl-silane or gamma-aminopropyltriethoxysilane. Hereinafter “amino-alkoxysilane” coupling agent includes any NR₂ containing alkoxysilane compound, where R is hydrogen, a linear alkyl group having 1-6 carbon atoms, a branched alkyl group having 2-12 carbon atoms, a cycloalkyl group having 3-17 carbon atoms, a fluorinated linear alkyl group having 2-12 carbon atoms, a fluorinated branched alkyl group having 2-12 carbon atoms, and a fluorinated cycloalkyl group having 3-17 carbon atoms.

In one embodiment, a concentration of the adhesion promoter is from about 0.01% to about 1%.

In one embodiment, a concentration of the adhesion promoter is from about 0.1% to about 1.0%.

In one embodiment, a concentration of the adhesion promoter is from about 0.5% to about 1.0%.

In one embodiment, a concentration of the adhesion promoter is from about 0.1% to about 0.5%.

In one embodiment, a portion of the outer walls and channels may be wrapped with a fabric, such as fiber glass cloth or mat.

### EXAMPLE 1

Blow molded HDPE thermoplastic core segments 22, as depicted in FIGS. 1-2 and described in associated text herein, were flame treated to activate the surface, followed by coating with an adhesion promoter. Adhesion promoter was applied by dipping the core segment 22 into a solution of the adhesion promoter. The adhesion promoter was not applied by brush. pH of the adhesion promoter was adjusted to less than 6.0 for all tests by adding acetic acid.

The adhesion promoter included the following components, available from:
a. Epoxy emulsion (45% solids, 174 epoxide equivalent weight (EEW) epoxy resin) ; Dow Chemical Company, Midland, Mich.;
b. amino-alkoxysilane (gamma-aminopropyltriethoxysilane) available from OSi, Inc.;
c. amino-alkoxysilane (gamma-aethacryloxypropyltrimethoxysilane) available from OSi, Inc.; and
d. Acetic Acid.

TABLE 1
Adhesion Results and Adhesion Promoter Composition of Components
in Adhesion Promoter (Weight Percent), balance water.

| Ingredients | Test 1 | Test 2 | Test 3 | Test 4 | Test 5 |
|---|---|---|---|---|---|
| amino-alkoxysilane | 0.1% | 0 | 0.2% | 0 | 0 |
| methacryl-alkoxysilane | 0.1% | 0 | 0 | 0.2% | 0 |
| epoxy emulsion | 1.0% | 1.0% | 1.0% | 1.0% | 0 |
| Adhesion with | Good | Poor | Poor | Good | Poor |
| unsaturated polyester | | | | | |
| resin, MEKP catalyst | | | | | |
| Adhesion to epoxy resin | Good | N/A | N/A | N/A | Good |

### Test Sample Fabrication

Samples for testing were fabricated with two core configurations. Core #1 was fabricated without fiberglass layers between the channels 26 and spaces 28 of the core segments 22 or 42. Core #2 was fabricated with glass reinforced webs inserted between the channels 26 and spaces 28 of the core segments 22 or 42 in the direction shown by the arrow 70 or the arrow 52, as depicted in FIG. 5 and described in associated text herein. Core #1 and #2 samples used 4 in.×4 in.×8 in. core segments 22 or 42 made from HDPE, with the long direction oriented through the thickness of the sandwich structure(s) 10 or 40. FIG. 10 shows the infusion mold 60 with core segments 22 being loaded into the cavity 68. FIG. 11 shows the loaded mold 60, with 2 layers 27 and 29 of continuous strand mat (CSM) being added to the top before covering and vacuum infusing with polyester resin. When infused, not shown, the sandwich structure samples were 20 inches (0.51 m) long, 8 inches (0.2 m) thick, and 12 inches (0.3 m) wide (3 segments wide by 5 segments long). The edges were then cut off of each so the resulting samples were 8″ (0.2 m) wide, FIG. 7, with effectively 2 webs each. Core #2 added one layer of 1.5 oz./sq.ft. (460 gsm) CSM inserted between core segments 42 running in the long direction, as shown by the direction of the arrow 70 in FIG. 5. The core segments 42 were sealed to prevent resin from getting inside, and the surface 48 was treated to promote adhesion to polyester resin. Face skins 44 and 46 were two layers of 1.5 oz./sq.yd. (460 gsm) continuous strand mat (CSM) each.

### Testing

Testing used a 120 kip (534 kN), Baldwin TateEmery universal testing machine in compression mode. Steel supports were placed under the sandwich panel ends, reducing the test span to 12″ (0.3 m), and a 4″ (0.1 m) wide steel plate was placed on top and centered. Since the sample is short and thick, this 3 point beam test is effectively a core shear test, very close to ASTMC393. The load frame was run in stroke control at 0.5 inches per minute (12.7 mm/min), and failure was taken to be when the load drops to 20% below its maximum value. In the case of Core #1, the core webs buckled but did not fail catastrophically at about 5,768 pounds (25.7 kN). As the webs buckled, the load dropped below 80% of the maximum, the test was stopped and the sample unloaded. Surprisingly, the webs un-buckled and the sample returned to nearly its original shape with little damage. According to ASTM C393 test parameters, the average shear strength of Core #1 based on this test was 45 psi (0.31 MPa).

Core #2 was tested in a similar way to an ultimate load of 15,488 pounds (69.0 kN). The webs cracked in a few places, but the sandwich panel retained a significant portion of its integrity. The average shear strength of Core #2 based on ASTM C393 was 121 psi (0.83 MPa) in the span-wise direction. Shear strength in the transverse direction is expected to be similar to that of Core #1.

### Estimating Core #1 Shear Strength

Typical tensile yield strength for HDPE is 4000 psi (27.6 MPa). Estimating the shear yield in a ductile material, ½ of the tensile-yield is often used, giving 2000 psi (13.8 MPa) shear strength for HDPE. For a single material, as in Core #1 (ignoring the bonding resin), the shear area of the webs multiplied by the appropriate shear strength of the webs estimates the shear capability of the cross section; because the shear stress in the core is nearly constant through the thickness. Given that the BMC segment wall thickness is nominally 0.045 inches (1.1 mm), and there are 4 segment thicknesses across the present test beams (2 webs, and 2 per web), and those webs are 8 inches (0.2 m) high, the shear capability of the cross section is estimated to be 2880 pounds (12.8 kN). From this the shear strength of Core #1 is estimated to be 45 psi (0.31 MPa). Since there are 2 cross sections supporting the beam in a 3 point loading situation, the maximum load for the beam is estimated to be 5,760 pounds (25.7 kN, 2×the cross section capacity). This is within 8 pounds (36N) of the tested value (about 0.1% error), way too close for engineering accuracy, more attributable to good luck. Nevertheless, it is very encouraging to see the predicted value so close to the tested value.

Hereinafter, “good” adhesion, as a criterion for adhesion in Table 1, supra, is defined as shear strength greater than or equal to 40 psi.

In contrast, when the sandwich structures Cores #1 and #2 were infused with epoxy resin instead of polyester and not treated with adhesion promoter, they demonstrated the same shear strength as Cores #1 and #2 infused with polyester and treated with adhesion promoter. That is, Cores #1 and #2 infused with epoxy resin instead of polyester without applying adhesion promoter to the oxidized surfaces of the walls 26 and spaces 28 of the sandwich structures demonstrated the same shear strength as Cores #1 and #2 infused with polyester and treated with adhesion promoter. Thus, even though the surface 48 was not treated to promote adhesion to the epoxy resin as it had been to promote adhesion to polyester resin, Cores #1 and #2 demonstrated the same shear strength as Cores #1 and #2 infused with polyester and treated with adhesion promoter.

Referring to the above discussion about Cores #1 and #2, in an embodiment of the method 50, depicted in FIG. 8 and described in text herein, providing epoxy resin instead of polyester resin and not treating the oxidized surface of the core segments 22 or 42 with adhesion promoter resulted in the sandwich structure having the same shear strength as it would have had from providing polyester resin and treating the oxidized surface of the core segments 22 or 42 with an adhesion promoter.

### Estimating Core #2 Shear Strength

It is more difficult to estimate the shear strength of Core #2 because the web is composed of two materials (actually three) HDPE skins on a CSM core, laminated with polyester resin. The web is therefore modeled as a laminate because the in-plane shear modulus of the component materials is significantly different; and we cannot simply add up the strength contribution from each component. We must use laminate theory, and invoke uniform (in-plane) shear strain in order to predict the proper sharing of stress between the various components.

First we will estimate some material properties. The 1.5 oz./sq.ft. (460 gsm) CSM center layer was 0.030″ (0.76 mm) thick, indicating a fiber content of 42% by weight, and thus an in-plane shear modulus in the range of 600 ksi (4.1 GPa). Combining the CSM with two layers of HDPE at 0.045″ (1.1 mm) thick each, with in-plane shear modulus in the 70 ksi (0.48 GPa) range, gives a load sharing distribution of 73% in the CSM and 27% in the HDPE. Further, considering that the CSM will fail before the HDPE, because the failure strain of the CSM is the lower of the two, the failure load is expected to be 36% higher that the CSM alone. Knowing this we can now make a strength estimate similar to Core #1.

Typical in-plane shear strength for the CSM at 42% fiber content is 10 ksi (68.9 MPa). At 0.030″ (0.76 mm) thick and 8″ (0.2 m) high, the failure shear load for one web is 2400 pounds (10.7 kN) for the CSM alone. Increasing this value by 36% according to the previous argument gives 3264 pounds (14.5 kN) for the web shear load at failure. Since there are 2 webs, and the section is 8″ (0.2 m) wide, the average shear strength of the core is estimated to be 102 psi (0.70 MPa). Comparing this to the measured value of 121 psi (0.83 MPa) indicates that the previous estimates were in a reasonable range. Core #2 is 20% stronger than predicted.

Sandwich structures

### Core Density

The core density must include the weight of the segments as well as the resin and glass within the core. Core density was calculated by weighing the test samples, subtracting the weight of the skins, and dividing by the remaining volume. The test sandwich panels weighed 5.0 and 5.5 pounds (2.27 and 2.5 kg) for Core #1 and Core #2 respectively; giving a core density from about 4.8 and 5.4 pounds per cubic foot (77 and 87 kg/m³) respectively. In one embodiment the sandwich structure had a core density from about 1.0 to about 30.0 pounds per cubic foot.

These values are in the range of typical medium density PVC foam core.

### Advantages

Some of the possible advantages of this type of core segments 22 or 42 are summarized below.

Advantages

Commodity process to make segments, scaleable, and relatively low cost.

Cost similar to HDPE bottles.

Core provides webs in two mutually perpendicular directions.

Able to easily provide thicknesses over 8 inches (0.2 m).

Segments can be molded with resin distribution grooves.

Drop-in for many vacuum infusion processes.

Difficult to peel skins off.

Resists damage and delamination.

### Conclusions

Hollow blow molded segments were successfully molded into a sandwich panel configuration using vacuum assisted resin transfer molding. The predicted shear strengths of the fiber glass reinforced and un-reinforced panels were reasonably close to the test values. The shear strength and damage resistance of the two core samples tested was significant. This type of core material could provide a cost effective option for sandwich structures equal to or greater than 4 in. thick.

The foregoing description of the embodiments of this invention has been presented for purposes of illustration and description. It is not intended to be exhaustive or to limit the invention to the precise form disclosed, and obviously, many modifications and variations are possible.

1. A sandwich structure, comprising:
a plurality of operably coupled contiguous hollow cores, each hollow core being characterized by only one inner cavity and an outer wall surrounding the inner cavity, wherein the walls do not allow communication between the cavities of the contiguous hollow cores, the walls of the contiguous hollow cores having channels and spaces therebetween, the channels and spaces being essentially completely filled with a cured resin,
wherein a portion of an outer surface of the walls and channels have been oxidized by treatment with a flame, corona discharge or chemical oxidizing agent before the channels and spaces therebetween have been essentially completely filled with the cured resin, so that the portion of the outer surface of adjacent walls and channels are chemically bonded to the adjacent walls and channels.

2. The apparatus of claim 1, wherein the cores are from about 4 in.×4 in.×8 in. to about 16 in.×16 in.×72 in. and a wall thickness of the cores is less than or equal to from about 0.015 to about 0.25 in.

3. The apparatus of claim 1, wherein oxidized surface of the walls and channels have been treated with an adhesion promoter after being oxidized by treatment with a flame, corona discharge or chemical oxidizing agent.

4. The apparatus of claim 1, wherein a portion of the outer walls and channels are wrapped with a fabric.

5. The apparatus of claim 4, wherein a material of the fabric is fiber glass.

6. A method of forming a sandwich structure, comprising:
providing a plurality of hollow cores, each hollow core being characterized by only one inner cavity and an outer wall surrounding the inner cavity, wherein the walls do not allow communication between the cavities, and wherein the walls of the hollow cores have channels;
oxidizing at least part of an outer surface of walls and channels of the plurality of hollow cores by treatment with a flame, corona discharge or chemical oxidizing agent;
assembling the plurality of hollow cores to form a an array of contiguous hollow cores, wherein the channels and spaces between adjacent cores of the array of contiguous hollow cores are in fluid communication with a resin;
providing the uncured resin through the channels and spaces between the walls of the contiguous hollow cores so that the at least part of the outer surface of the walls and channels of adjacent hollow cores are chemically bonded to the outer surfaces of the walls and channels of another adjacent hollow core; and
curing the resin to form the sandwich structure.

7. The method of claim 6, wherein the plurality of cores are made of a thermoplastic material selected from the group consisting of a low density polyethylene material, LDPE, a low density polypropylene material, LDPE, a high density polyethylene material, HDPE, a high density polypropylene material, HDPE, a polysulfone material, and polysulfone ether material.

8. The method of claim 6, comprising adjusting a pH of an adhesion promoter to less than 6.0 and treating the outer surface of the walls and channels of the plurality of cores with the adhesion promoter after oxidizing the at least part of the outer surface of walls and channels of the plurality of cores by treatment with the flame, corona discharge or chemical oxidizing agent.

9. The method of claim 6, wherein providing epoxy resin instead of polyester resin and not treating the oxidized surface of the cores with an adhesion promoter resulted in the sandwich structure having the same shear strength as it would have had from providing polyester resin and treating the oxidized surface of the cores with an adhesion promoter.

10. The method of claim 6, comprising wrapping a portion of the outer walls and channels with a fabric.

11. The method of claim 6, comprising wrapping a portion of the outer walls and channels with fiber glass cloth or mat.

12. The method of claim 8, wherein the adhesion promoter includes gamma-methacryloxypropyltrimethoxysilane or gamma-aminopropyltriethoxysilane.

13. The method of claim 8, wherein the adhesion promoter includes an amino-alkoxysilane coupling agent.

14. The method of claim 8, wherein a concentration of the adhesion promoter is from about 0.01% to about 1.0%.

15. The method of claim 8, wherein a concentration of the adhesion promoter is from about 0.1% to about 1.0%.

16. The method of claim 8, wherein a concentration of the adhesion promoter is from about 0.5% to about 1.0%.

17. The method of claim 8, wherein a concentration of the adhesion promoter is from about 0.1% to about 0.5%.

18. The method of claim 8, wherein the adhesion promoter includes an epoxy emulsion surfactant.

19. A sandwich construction, comprising a structure having at least one layer of hollow core segments consisting of a combination of relatively high-strength facing materials intimately bonded to and acting integrally with the low-density hollow core segments.

20. The sandwich construction of claim 19, wherein a thickness is at least 4 in. thick.

21. The sandwich construction of claim 19, wherein a core density was from about 4.8 to about 5.4 pounds per cubic foot (77 and 87 kg/m³).

22. The sandwich construction of claim 19, wherein a core density was from about 1.0 to about 30.0 pounds per cubic foot.

23. The sandwich construction of claim 19, wherein the outer surface of the walls and channels have been have been treated with an adhesion promoter after the outer surface of the walls and channels have been oxidized by treatment with a flame, corona discharge or chemical oxidizing agent.
